(19) United States
(12) Patent Application Publication
(10) Pub. No.: US 2004/0162119 A1
(43) Pub. Date: Aug. 19, 2004

(54) Wireless earset phone

(76) Inventor: Yoo-Seok Jeong, Seoul (KR)

Correspondence Address: Galgano & Burke, 300 Rabro Drive, Suite 35, Hauppauge, NY, 11788, US

(21) Appl. No.: 10/640,183

(22) Filed: Aug. 13, 2003

(30) Foreign Application Priority Data
Feb. 14, 2003 (KR) 2003-9435

(51) Int. Cl. H04B 1/034

(52) U.S. Cl. 455/575.2; 455/90.3; 455/100

(57) ABSTRACT

A wireless earset phone. The phone includes a phone base and an earset. The earset has an earset body and a projected part. The earset body has on a front surface thereof a button part. An ear speaker projects from one side on a rear surface of the earset body. An accommodating space is defined at a center portion on the rear surface of the earset body to accommodate electronic components therein. A switch is provided on a rear surface of and adjacent to one end of the projected part. A transmitter is provided on the rear surface of and adjacent to the other end of the projected part. A ring is provided below the transmitter so that an accessory collar can be connected to the ring to allow the earset to be put around the neck of the user.

### BACKGROUND OF THE INVENTION

1. Field of the Invention

The present invention relates, in general, to a wireless earset phone in which an earset is constructed in the form of an earpiece to enable hands-free communication of a user. More particularly, the present invention relates to a wireless earset phone, wherein an earset is configured in the form of an earpiece to be capable of being supported by an accessory collar, in a manner such that communication can be conducted with an ear speaker of the earset inserted into a user's ear when a telephone call is received, whereby the portability of the earset is improved and inconvenience is minimal since it is not necessary to grasp the earset with one hand, instead, both hands of the user are free while communicating over the earset, and wherein the earset is configured to have a low weight and the ear speaker is configured to have excellent wearability, in a manner such that the user does not feel uncomfortable even when the earset is used for extended periods, whereby the value of the wireless earset phone can be improved.

2. Description of the Related Art

As well known to those skilled in the art, most wired or wireless phones used for transmitting and receiving messages to and from counterparts are designed to be grasped by the hand. Hence, inconvenience is caused when it is necessary for a person to use both hands while using the phone.

For example, inconvenience is caused to a user in the case of looking for a book, manipulating a keyboard of a computer, cooking or dishwashing in the kitchen, or cleaning a house, while talking over the phone.

In order to cope with this problem, a number of headset phones have been disclosed in the art. However, in these headset phones, since a position of a microphone is uniformly fixed, in the case of a user having a large-sized head, it is difficult for the user to speak clearly into the microphone.

Further, because the phone of the conventional 900 MHz or 2.4 GHz wireless phone system occupies a large volume, has a substantial weight and must be grasped by one hand while using the phone, inconvenience is caused in that neither hand is free for conducting other tasks. In addition, after the phone is used, it may be necessary to try to find where the phone is, for example, by pressing a page button provided to a phone base of the wireless phone system, whereby time may be wasted and inconvenience may be caused. Also, in the case of using the wired headset phone, it is difficult to freely conduct other tasks while using the phone, due to a limited length of a cord which connects the headset with a phone base.

Consequently, the conventional phones or headset phones suffer from defects in that inconveniences and annoyances are caused to active users, whereby the value of the phones cannot but be deteriorated and user satisfaction is diminished.

### SUMMARY OF THE INVENTION

Accordingly, the present invention has been made keeping in mind the above problems occurring in the related art, and an object of the present invention is to provide a wireless earset phone wherein an earset is configured to be connected by an accessory collar in the form of a necklace to thereby be conveniently carried, in a manner such that communication can be made with an ear speaker of the earset inserted into a user's ear when a telephone call is received, whereby the portability of the earset is improved and inconvenience is minimal since it is not necessary to grasp the earset with one hand and instead both hands of the user can be free for conducting other tasks while communicating over the earset.

Another object of the present invention is to provide a wireless earset phone wherein an earset is configured to have a low weight and an ear speaker is configured to have excellent wearability, in a manner such that a user does not feel uncomfortable even when the earset is used for extended periods.

Still another object of the present invention is to provide a wireless earset phone which is constructed to increase the value of the wireless earset phone and user satisfaction.

In order to achieve the above object, according to the present invention, there is provided a wireless earset phone including a phone base for receiving signals via a communication line and an earset for wirelessly transmitting and receiving signals to and from the phone base, wherein the earset has an earset body and a projected part which are integrally formed with each other, the earset body possessing a circular shape, and the projected part projecting from one end of the earset body by a predetermined length; the earset body has, on a front surface thereof, a button part on which a plurality of number buttons and symbol buttons to be manipulated by a user are arranged along a circular path; an ear speaker is provided to project from one side on a rear surface of the earset body so that the ear speaker can be inserted into the user's ear to allow the user to receive communication, and an accommodating space is defined at a center portion on the rear surface of the earset body so that electronic components such as a chip, etc. can be accommodated in the accommodating space; and a switch is provided on a rear surface of and adjacent to one end of the projected part so that the user can turn the switch on and off, a transmitter is provided on the rear surface of and adjacent to the other end of the projected part so that the voice of the user can be transmitted by the transmitter to the phone base, and a ring is provided below the transmitter so that an accessory collar can be connected to the ring to allow the earset to be put around the neck of the user.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a wireless earset phone in accordance with an embodiment of the present invention;

FIG. 2 is a perspective view illustrating an earset according to the present invention;

FIG. 3 is a front view of the earset shown in FIG. 2;

FIG. 4 is a rear view of the earset shown in FIG. 2;

FIG. 5 is a side view of the earset shown in FIG. 2;

FIG. 6 is a view illustrating a state wherein the earset according to the present invention is connected to an accessory collar; and

FIG. 7 is a view illustrating an in-use state of the earset according to the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

In the description given hereinbelow, if it is quite likely that conventional functions of components and conventional methodology adopted in the present invention will make the gist of the present invention unclear, detailed explanation thereof will be omitted.

Further, it is to be noted that the technical terms used in the description given hereinbelow were selected in consideration of functionality of the corresponding components. Therefore, since the technical terms may be changed depending upon a desire of a manufacturer and the practice in the art, definitions thereof must be given on the basis of the entire contents of the present specification.

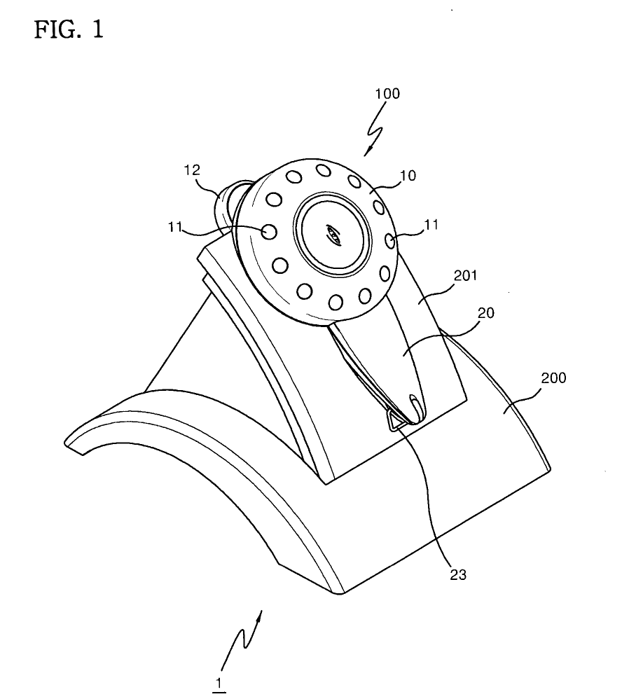

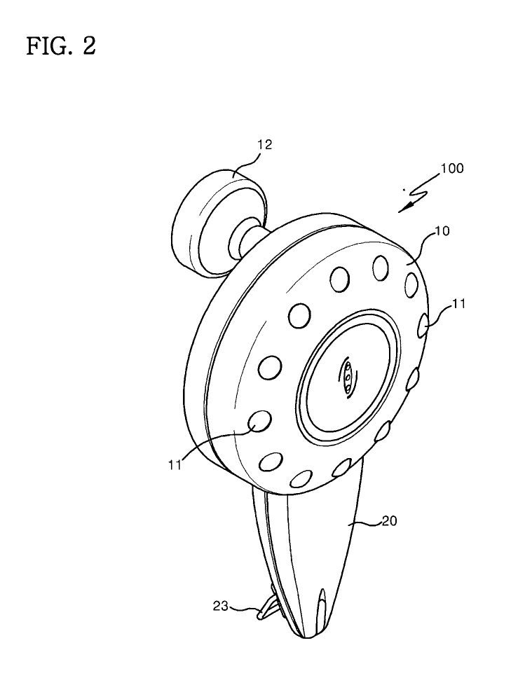

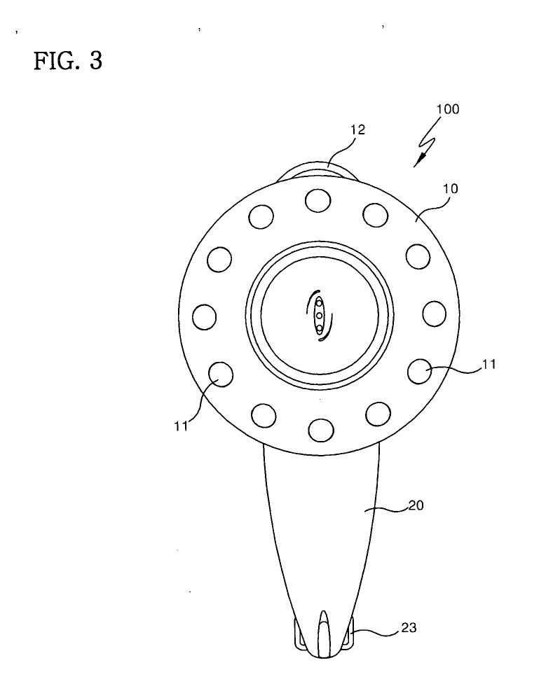

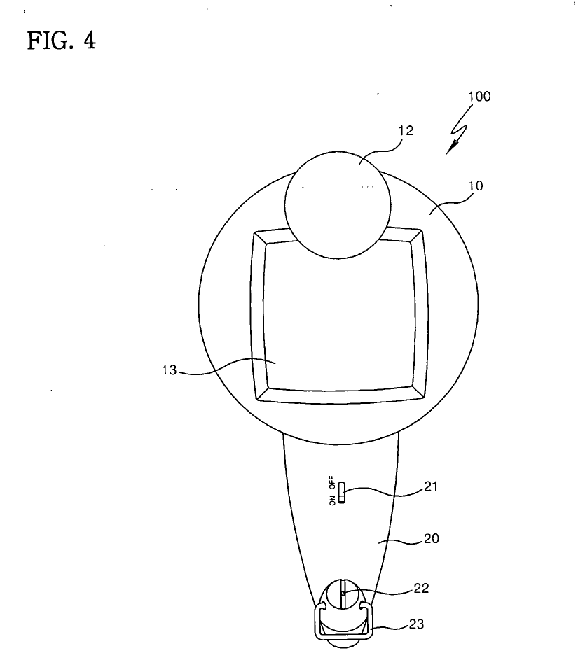

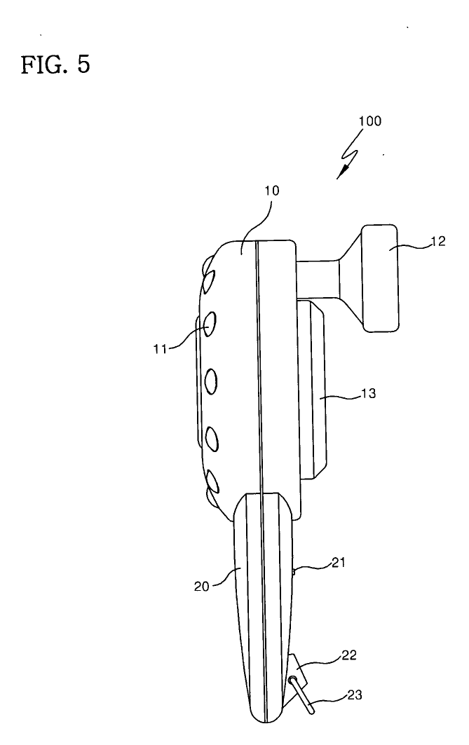

Referring to FIGS. 1 through 7, a wireless earset phone 1 in accordance with an embodiment of the present invention includes a phone base 200 for receiving signals via a communication line and an earset 100 for wirelessly transmitting and receiving signals to and from the phone base 100. The earset 100 has an earset body 10 and a projected part 20 which are integrally formed with each other. The earset body 10 possesses a circular shape, and the projected part 20 projects from one end of the earset body 10 by a predetermined length. The earset body 10 has, on a front surface thereof, a button part 11 on which a plurality of number buttons and symbol buttons to be manipulated by a user are arranged along a circular path. An ear speaker 12 is provided to project from one side on a rear surface of the earset body 10 so that the ear speaker 12 can be inserted into the user's ear to allow the user to receive communication. An accommodating space 13 is defined at a center portion on the rear surface of the earset body 10 so that electronic components such as a chip, etc. can be accommodated in the accommodating space 13. A switch 21 is provided on a rear surface of and adjacent to one end of the projected part 20 so that the user can turn the switch 21 on and off. A transmitter 22 is provided on the rear surface of and adjacent to the other end of the projected part 20 so that the voice of the user can be transmitted by the transmitter 22 to the phone base 200. A ring 23 is provided below the transmitter 22 so that an accessory collar 30 can be connected to the ring 23 to allow the earset 100 to be put around the neck of the user.

The phone base 200 is defined with a depression 201 which has a contour corresponding to that of the earset 100 so that the earset 100 can be normally placed in the depression 201.

A person skilled in the art will readily recognize that the construction of the wireless earset phone 1 according to the preferred embodiment of the present invention can be modified in several ways.

In the wireless earset phone 1 according to the present invention, the phone base 200 receives signals by way of the communication line. The earset 100 and the phone base 200 are configured in a manner such that they can wirelessly transmit and receive signals to and from each other, by which the user can have a conversation with a counterpart.

To this end, when the user wants to have a conversation with the counterpart using the wireless earset phone 1, the user first releases the earset 100 which is placed in the depression 201 of the phone base 200.

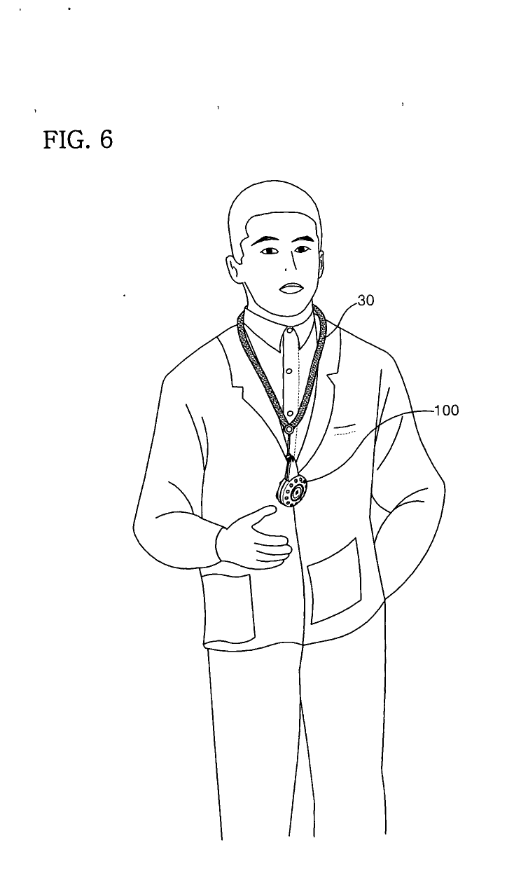

At this time, the accessory collar 30 which is connected to the ring 23 of the projected part 20 integrally formed on the earset 100 is put around the neck of the user (see FIG. 6). Then, the ear speaker 12 which projects from the rear surface of the earset body 10 is inserted into the user's ear. In this state, it is possible to hear the voice of the counterpart, that is, communication, through the ear speaker 12, and transmit the voice of the user to the counterpart through the transmitter 22.

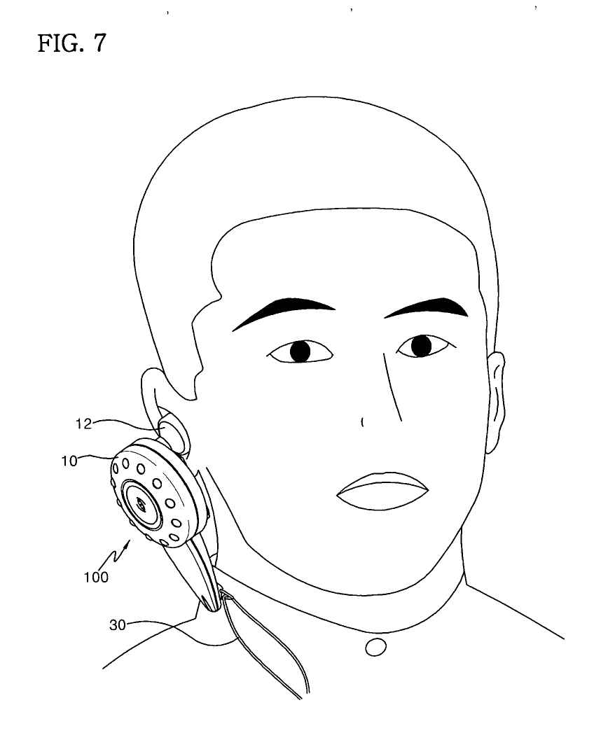

In the present invention, due to the fact that the earset 100 is configured to have a small size, it is possible to communicate over the earset 100 with both hands of the user not touching the earset 100 and the ear speaker 12 inserted into the user's ear (see FIG. 7).

Since the signal receiving and transmitting procedures between the user and the counterpart are implemented in the same manner as in the conventional phone, detail explanation thereof will be omitted herein.

When the user makes a telephone call to the counterpart using the earset 100 and when the user receives a telephone call from the counterpart using the earset 100, the wireless earset phone 1 is operated in a similar manner. However, in the case that the user makes a telephone call to the counterpart, the user should first press some of the buttons arranged on the button part 11 which is provided on the front surface of the earset body 10 having the circular shape, to input a phone number of the counterpart.

Thereafter, as the counterpart corresponding to the inputted telephone number receives the telephone call, it is possible to talk over the phone as described above.

The user can easily turn the earset 100 on and off through the switch 21 which is provided on the rear surface of the projected part 21. Due to the fact that the earset 100 of the wireless earset phone 1 is configured to have a small size in a state wherein the earset body 10 and the projected part 20 are integrated with each other, everyone can conveniently use the wireless earset phone 1 regardless of age or sex.

When the earset 100 is not used, the earset 100 can be easily placed in the depression 201 which is defined in the phone base 200. Since the depression 201 has the contour corresponding to that of the earset 100, the earset 100 can be stably held in the depression 201.

Electronic components such as a chip and the like can be accommodated in the accommodating space 13 which is defined at the center portion on the rear surface of the earset body 10. In order to minimize the size of the earset 100 of the wireless earset phone 1, the chip comprises a Merlin Device Set Family (DSP chip) manufactured by Conexant, which allows numerous chips used in the existing phone to be replaced with one chip.

Also, in an effort to decrease a size of the earset 100 of the wireless earset phone 1 and thereby improve the portability thereof, in the present invention, instead of the Ni-CD or Ni-MH battery used in the conventional wireless telephone, a lithium-ion polymer battery having a size of 20 mm×30 mm and a weight of 4.8 g is used. Besides, among various kinds of electronic components for a wireless telephone, those having minimum size and weight are employed in the present invention, such as a Doum switch, a microphone, a connector, a buzzer, etc. Detailed explanation of these components will omitted herein.

Finally, the wireless earset phone 1 according to the present invention adopts a 2.4 GHz DSST communication pattern to remove cross-wires during communication and ensure privacy and at the same time a 900 MHz analog communication pattern to suit a consumer's taste. In the present invention, because it is possible to transmit and receive a telephone call with the ear speaker 12 of the earset 100 directly inserted into the user's ear, it is not necessary to grasp the earset 100 with one hand. Thus, both of the user's hands are free for conducting other tasks while communicating over the earset 100.

As apparent from the above description, the wireless earset phone according to the present invention provides advantages in that an earset is configured to be connected by an accessory collar in the form of a necklace to thereby be conveniently carried, in a manner such that communication can be made with an ear speaker of the earset inserted into a user's ear when a telephone call is received, whereby the portability of the earset is improved and inconvenience is minimal since it is not necessary to grasp the earset with one hand, rather, both hands of the user are then free for conducting other tasks while using the earset. Further, due to the fact that the earset is configured to have a low weight and the ear speaker is configured to have excellent wearability, the user does not feel uncomfortable even when the earset is used for extended periods. Moreover, the wireless earset phone according to the present invention is constructed to improve the value of the wireless earset phone and accomplish user satisfaction.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A wireless earset phone including a phone base for receiving signals via a communication line and an earset for wirelessly transmitting and receiving signals to and from the phone base, wherein:
the earset has an earset body and a projected part which are integrally formed with each other, the earset body possessing a circular shape, and the projected part projecting from one end of the earset body by a predetermined length;
the earset body has, on a front surface thereof, a button part on which a plurality of number buttons and symbol buttons to be manipulated by a user are arranged along a circular path;
an ear speaker is provided to project from one side on a rear surface of the earset body so that the ear speaker can be inserted into the user's ear to allow the user to receive communication, and an accommodating space is defined at a center portion on the rear surface of the earset body so that electronic components such as a chip, etc. can be accommodated in the accommodating space; and
a switch is provided on a rear surface of and adjacent to one end of the projected part so that the user can turn the switch on and off, a transmitter is provided on the rear surface of and adjacent to the other end of the projected part so that the voice of the user can be transmitted by the transmitter to the phone base, and a ring is provided below the transmitter so that an accessory collar can be connected to the ring to allow the earset to be put around the neck of the user.

2. The wireless earset phone as set forth in claim 1, wherein the phone base is defined with a depression which has a contour corresponding to that of the earset so that the earset can be normally placed in the depression.
